(19) United States
(12) Patent Application Publication
(10) Pub. No.: US 2009/0173223 A1
(43) Pub. Date: Jul. 9, 2009

(54) ACTUATOR, DRIVING DEVICE, HAND DEVICE, AND CONVEYANCE DEVICE

(75) Inventors: Tatuwo Kudawara, Kyoto (JP); Mikio Shimizu, Kyoto (JP); Yasunori Ichikawa, Kyoto (JP)

Correspondence Address: TUROCY & WATSON, LLP, 127 Public Square, 57th Floor, Key Tower, CLEVELAND, OH, 44114, US

(73) Assignee: SQUSE INC.,, Nakagyo-ku, Kyoto (JP)

(21) Appl. No.: 12/162,577

(22) PCT Filed: Feb. 13, 2006
(86) PCT No.: PCT/JP2006/302441

§ 371 Date: Jul. 29, 2008

(51) Int. Cl. F15B 15/10

(52) U.S. Cl. 92/92

(57) ABSTRACT

A fluid pressure-type actuator is stably operable for a longer period of time than that of a conventional actuator. The actuator 1 is formed with a non-rubber bag body 5 covered with a covering body 2 that is expandable and contractable. The bag body 5 is constructed so that both a longitudinal dimension and an outer diameter thereof when inflated to the maximum extent are larger than an inner longitudinal dimension and inner diameter of the covering body 2 when the covering body 2 is expanded to the maximum extent. The covering body 2 is constructed so as to have a constricting force against a pressing force caused by inflating the bag body 5 when the covering body 2 is expanded to the maximum extent. If fluid is supplied to the actuator 1, because the bag body 5 is restrained with the covering body 2 before inflated to the maximum extent, an explosion of the bag body 5 is prevented. In addition, because the bag body 5 is made of non-rubber material, the actuator 1 can be stably operated for a long period of time without causing problems, such as degradation of the rubber.

### TECHNICAL FIELD

The present invention relates to an actuator in which a longer-term stable use and thinning thereof are realized compared to a conventional fluid pressure-type actuator, and a driving device, a hand device, and a conveyance device using the actuator.

### BACKGROUND ART

Conventionally, various fluid pressure-type actuators exist in which fluid, such as air and liquid is supplied to a bag body to inflate the bag body to operate an object. Among such fluid pressure-type actuators, there is a so-called McKibben actuator used for driving artificial muscles of a robot, driving various driving devices, and the like.

The McKibben actuator is generally constituted with a bag body made of an elastic material containing a rubber component, and an expandable and contractable covering body for covering the bag body. Although the covering body deforms as the bag body is inflated, hard textiles are generally used to control an excessive inflation of the bag body. The McKibben actuator converts the inflation of the bag body into a contracted deformation of the covering body in the longitudinal direction to obtain a required operating force (operating amount) (refer to Patent Documents 1 and 2). In some McKibben actuators, at least any of polyester, polyamide, polyethylene, polyimide, polystyrene, and polycarbonate is used as a material of the bag body (tube) instead of rubber having elasticity (refer to Patent Document 3).

[Patent Document 1] Japanese Unexamined Patent Application Publication No. 2003-301807

[Patent Document 2] Japanese Unexamined Patent Application Publication No. 2001-355608

[Patent Document 3] Japanese Unexamined Patent Application Publication No. 2004-105262

### DISCLOSURE OF THE INVENTION

### Problems to be Solved by the Invention

As shown in Patent Documents 1 and 2, among the conventional McKibben actuators, some of which using the elastic body containing the rubber component as its bag body may cause a problem in which an expansion-and-contraction characteristic of the bag body degrades by aging. Specifically, the rubber component contained in the bag body material deteriorates by oxidizing with oxygen and ozone, and the like, while an expansion-and-contraction property decreases because of material fatigue caused by a number of expansions and contractions, and thereby a good operational characteristic cannot be maintained for a long period of time.

For the actuator using the elastic body containing the rubber component as the bag body, when supplied with fluid, elasticity itself of the bag body becomes a load upon the fluid supply. Therefore, there is a problem that a large external fluid supply source by which the fluid can be supplied with a higher supply pressure than its load is required. Further, for the actuator using the elastic body containing the rubber component as the bag body, because a thickness of the bag body is in mm (millimeter) order considering characteristics of its raw material (material), thinning of the actuator is difficult. In addition, because an expansion limit exists in the rubber component when the elastic body containing the rubber component is used as the bag body, a contraction ratio of the actuator (ratio of a length upon the fluid supply with respect to a length upon the non-fluid supply) remains at a low limit value (approximately 20%).

On the other hand, as shown in Patent Document 3, for an actuator to which a bag body without using a rubber material is applied, another problem arises instead of causing various problems associated with containing the rubber component in the bag body. That is, the problem is that the bag body does not have elasticity, the bag body cannot be elastically deformed when a fluid supply amount is excessive, and thereby the bag body is easily exploded. In order to prevent the explosion and ensure a good contraction ratio (approximately 30% or more), a dimensional relationship between the bag body and the covering body for covering the bag body are required to be appropriately defined. However, because the dimensional definition is not described in Patent Document 3, there is a problem in that a stable operation of the actuator and the good contraction ratio cannot be ensured.

The present invention is made in view of the problems stated hereinabove. By not using the rubber material as the bag body, while appropriately defining the dimensional relationship between the bag body and the covering body, the present invention aims at providing a thinner actuator that can ensure a stable operation thereof for a long period of time with an improved contraction ratio compared to the conventional actuator.

In addition, the present invention aims at proving a driving device, a hand device, and a conveyance device that can be effectively utilized in a robot, an industrial field, and the like by using the actuator.

### Means for Solving the Problems

In order to solve the problems described above, an actuator, according to the present invention, includes a bag body that is inflated when supplied with fluid, and a covering body that covers the bag body, and expands and contracts as the bag body is deformed. The actuator is characterized in that the bag body is formed of a non-rubber material, while the maximum volume of the bag body when inflated to the maximum extent is greater than the maximum internal volume of the covering body when the covering body is expanded to the maximum extent, and the covering body has a constricting force to suppress the inflation of the bag body when expanded to the maximum extent.

According to the present invention, because the bag body is formed of the non-rubber material, conventional various problems that have been caused by containing the rubber component are not caused. In addition, the stable operational characteristic can be ensured for a long period of time, the load resistance upon the fluid supply is reduced as well, and thereby the actuator can be stably operated even if the fluid supply is at a lower pressure than that of the conventional actuator. Because the maximum volume of the bag body is greater than the maximum inner volume of the covering body, while the constricting force in the maximum expanded condition of the covering body is larger than a force generated when the bag body is inflated, explosion of the bag body due to inflation is prevented, by the constriction of the covering body. Therefore, the good operating condition can be maintained for a long period of time to prevent unintentional breaking of the actuator. As the non-rubber material, materials not containing various synthetic rubber components and various natural rubber components may be applied (similar for the rest of the Specification). The term “maximum volume of the bag body” means a volume when the bag body is inflated to the maximum extent within a range in which the bag body will not explode, and the term “maximum inner volume of the covering body” means an inner volume when the covering body is inflated (expanded) to the maximum extent within a range in which the covering body is not broken.

The actuator of the present invention includes a bag body that is inflated when supplied with fluid, and a covering body that covers the bag body, and expands and contracts as the bag body is deformed. The actuator is characterized in that the bag body is formed of a non-rubber material, while the maximum outer diameter of the bag body when inflated to the maximum extent is larger than the maximum inner diameter of the covering body when the covering body is expanded to the maximum extent, and the covering body has a constricting force to suppress the inflation of the bag body when the covering body is expanded to the maximum extent.

Also in this aspect of the invention, because the bag body may be formed of the non-rubber material, various problems caused by containing the rubber component are solved to ensure the stable operational characteristic for a long period of time, and thereby the actuator can be stably operated even if the fluid supply is at a lower pressure. Because the maximum outer diameter of the bag body is larger than the maximum inner diameter of the covering body, while the constricting force in the maximum expanded condition of the covering body is greater than the force generated when the bag body is inflated, the bag body is reliably constricted by the covering body so that explosion due to the inflation is prevented. As a result, the operation of the actuator can be stabilized for a long period of time. In the condition in which the covering body is expanded to the maximum extent by inflating the bag body, it is preferable that the bag body is formed so as to entirely contact an outer circumferential surface of the inflated bag body with an inner circumferential surface of the bag body in terms of reliably preventing the explosion of the bag body. The term “maximum outer diameter of the bag body” means an outer diameter (diameter of the outer circumferential surface) when the bag body is inflated to the maximum extent within a range in which the bag body will not explode, and the term “maximum inner diameter of the covering body” means an inner diameter (diameter of the inner circumferential surface) when the covering body is inflated (expanded) to the maximum extent in a rugby-ball shape within a range in which the covering body is not broken.

The actuator, according to the present invention, is characterized in that the material of the bag body is synthetic polymer or paper. In this aspect of the present invention, because synthetic polymer or paper through which fluid does not pass may be used as the material of the bag body, the bag body for the actuator can be easily manufactured at a low cost. As the synthetic polymer, the material containing at least one component, such as polypropylene, vinyl chloride, Teflon®, polyester, polyamide, polyethylene, polyimide, polystyrene, and polycarbonate may be applied. As for the paper, a paper-balloon-like shape is preferable in terms of being inflated by the fluid.

Further, the actuator, according to the present invention, may be characterized in that the material of the bag body has a thickness of a sheet portion of 20 μm or greater but not exceeding 400 μm.

In this aspect of the invention, because the thickness the sheet portion of the material is 20 μm or greater but not exceeding 400 μm, the overall thickness of the bag body is thinner than that in a case in which a material containing the rubber component may be used. Accordingly, a thickness of the actuator itself is reduced, and thereby the thinning of the actuator can be realized. By setting the thickness of the bag body within the range described above, a degree of the expansion and contraction at the time of the non-fluid supply and the fluid supply can be increased, and thereby contributing to increasing the contraction ratio of the actuator, and increasing the operating amount compared to that of the conventional actuator of the same size. If giving priority to the thinning of the actuator, it is preferable that the thickness of the sheet portion of the bag body is 200 μm or less per sheet, furthermore, 100 μm or less. On the other hand, if emphasizing on durability of the bag body, it is preferable that the thickness of the sheet portion of the bag body is 200 μm or more.

The actuator, according to the present invention, may be characterized in that the bag body is formed with a folding portion to be a folding line without fluid being supplied.

In this aspect of the invention, because the folding portion is formed on the bag body, the bag body can be naturally folded along the folding portion without fluid being supplied and the bag body is contracted. Therefore, even if the bag body with a lager maximum volume than that of the covering body, or the bag body with a larger maximum outer diameter than that of the covering body is used, the bag body can be made compact when fluid is not supplied, and thereby contributing to the thinning of the actuator. Of course, a plurality of the folding portions may be formed on the bag body. If a plurality of the folding portions are formed, the bag body can be further made compact when the fluid is not supplied.

It is preferable that the folding portion is formed in a direction perpendicular to the radial direction of the bag body. By forming the folding portion as described above, the bag body is inflated easily and smoothly in the radial direction when the fluid is supplied. In addition, when the fluid is not supplied, the bag body is easily contracted along the folding portion as a folding line without being thick, and thereby further increasing a dimensional difference in the radial direction between in the inflation and in the contraction of the bag body.

The actuator, according to the present invention, may be characterized in that the bag body has a plurality of openings through which fluid passes.

In this aspect of the invention, because the bag body has the plurality of the openings for passing fluid, variation is caused according to the methods for supplying fluid to the bag body. For example, an opening dedicated to supplying and an opening dedicated to exhausting the supplied fluid may be determined to operate the actuator. In such case, the fluid may smoothly flow along a predetermined direction. In order to improve an operational response of the actuator, the bag body is supplied to the bag body simultaneously through a plurality of the openings. In addition, when the bag body is contracted, fluid is exhausted simultaneously through the plurality of the openings, and thereby a large amount of fluid may be supplied to and exhausted from the bag body in a short time.

The actuator, according to the present invention, may be characterized in that the covering body is knitted with threads made of esters.

In this aspect of the invention, because the covering body is knitted with the ester threads that are difficult to be expanded and contracted, the covering body is softer than that of the conventional McKibben actuator to sensitively follow the inflation of the bag body, and thereby obtaining the operational characteristic with high response. In addition, the actuator that is reliably operable even at approximately 20 kPa of fluid supply pressure can be obtained, and thereby contributing to reducing the size of the actuator. For knitting the covering body, threads of multifilament and monofilament may be combined, or only multifilament thread may be used.

The actuator, according to the present invention, may be characterized in that the covering body is knitted with threads that are less than 330 decitex.

In this aspect of the invention, because the covering body is knitted with the threads that are less than 330 decitex, the covering body is softer than that knitted by hard textiles used for the conventional actuator to follow a delicate deformation of the bag body, and thereby improving the operational response associated with fluid supply.

The actuator, according to the present invention, may be characterized in that the covering body is knitted by a textile braided method, stitches of which being rhombic, and the longitudinal direction of the rhombic when fluid is not supplied being coincident with a direction perpendicular to the radial direction of the bag body.

In this aspect of the invention, because the covering body is knitted by a method called “textile braided,” a soft covering body that is preferable for covering the bag body, and can flexibly follow the expansion of the bag body may be formed. By being coincident the longitudinal direction of the rhombic (bias) stitches in a condition in which the covering body is not expanded and contracted (the condition in which fluid is not supplied) with the direction perpendicular to the radial direction of the bag body, the expansion and contraction amount in the radial direction of the covering body and the bag body can be increased, and thereby contributing to the increasing in the operating amount.

A driving device, according to the present invention, is characterized including a first member, a second member rotatably coupled to the first member, the above-described actuator arranged on the first member, and a wire member connecting the actuator and the second member.

In this aspect of the invention, because the first member and the second member are rotatably coupled, while the actuator arranged on the first member is connected to the second member with the wire member, the second member is pulled to be rotated as the actuator is operated. To the driving device performing such rotation, because the actuator having the long-term stable operational characteristic as described above, and the increased contraction ratio is applied, the operability is not decreased by use compared to that of the conventional actuator, and thereby obtaining the driving device with the increased rotation range of the second member.

The driving device, according to the present invention, may be configured so that three or more members are linearly and rotatably coupled with each other. For example, the driving device may be realized in which a third member is further rotatably coupled to the second member that is rotatably coupled to the first member, while a first actuator for the rotation of the second member is arranged on the first member, and a second actuator for the rotation of the third member is arranged on the second member. By linearly coupling the plurality of the driving devices, a movement just like a human finger can be realized, and thereby providing a construction that is preferable for fingers of a hand portion of a robot.

A hand device, according to the present invention, is characterized by including the plurality of the driving devices as described above, wherein the first members of the driving devices are integrally combined.

In this aspect of the invention, because the first members of the plurality of the driving devices are integrally combined, a portion into which the first members are integrally combined together is a section corresponding to a human palm, and the plurality of the rotatable second members project like fingers from the section corresponding to the human palm. Therefore, the hand device similar to a human hand can be realized, and because the actuator with the construction as described above is applied, the hand device that can be stably operated for a long period of time by increasing the rotation range of the second member can be provided. In order to ensure a movement equivalent to that of a human hand, five driving devices are required to be combined similar to human fingers. Such hand device that can realize the movement equivalent to a human hand may be utilized as a hand portion of a humanoid robot or an artificial hand.

The hand device, according to the present invention, may be characterized by including the actuator as described above, an arranging member to arrange the actuator, and an opposed member arranged oppositely to the actuator with a space therebetween.

In this aspect of the invention, by arranging the opposed member to the actuator with the space therebetween, while expanding the actuator to be operated by supplying fluid, the space distance between the actuator and the opposed member may be shortened. Therefore, if an object is positioned in the space in the hand device, the object is pinched with the actuator and the opposed member. Because the actuator as described above is applied to the hand device with such construction, the actuator can be stably operated for a long period of time, while the expansion ratio in the radial direction of the actuator is increased in accordance with the improvement of the contraction ratio, objects in various size may be pinched, and thereby realizing a preferable hand device in a place where a work piece is grabbed in a manufacturing equipment.

A conveyance device, according to the present invention, is characterized in that a plurality of the actuators as described above are parallely arranged so that an object to be conveyed is placed on the actuators, and the conveyance device comprises a switching means for sequentially switching fluid supplies to each of the actuators.

In this aspect of the invention, because the plurality of the actuators are parallely arranged, while fluid supply to each of the actuators is sequentially switched, the parallely arranged actuators are sequentially expanded to be operated. Therefore, because a height of the location where the object is placed sequentially changes, the object advances to a direction into which the fluid supply is switched so as to slide down by gravity, and thereby the object can be smoothly conveyed. In particular, for the conveyance device of the present invention, because the expansion ratio in the radial direction of the actuator is high, a change in height increases, and thereby the object can be quickly conveyed.

### ADVANTAGES

According to an aspect of the invention, because the maximum volume of the non-rubber bag body is greater than the maximum inner volume of the covering body, while the covering body suppresses the bag body to be inflated in the condition in which it is expanded to the maximum extent, various problems caused by using the bag body containing the conventional rubber component can be solved, the bag body is not inflated until being exploded, and thereby the long-term stable operation can be ensured.

In addition, according to an aspect of the present invention, because the maximum outer diameter of the non-rubber bag body is larger than the maximum inner diameter of the covering body, while the bag body is prevented from being inflated until being exploded by the constriction by the covering body, various problems associated with the bag body containing the conventional rubber component can be solved, and thereby the stable operation of the actuator can be ensured for a long period of time.

According to an aspect of the present invention, because the synthetic polymer or the paper is used as the material of the bag body, the bag body for the actuator can be easily manufactured with a reasonable material.

In addition, according to an aspect of the present invention, because the thickness of a sheet portion of the material for the bag body is 20 μm or greater but not exceeding 400 μm, the bag body is thinned when the fluid is not supplied, and thereby the thinning of the actuator can be realized.

According to an aspect of the present invention, because the folding portion is formed on the bag body, even if the bag body that is larger than the covering body is used, the bag body can be compactly accommodated when fluid is not supplied, and thereby contributing to the thinning of the actuator, while contributing to the improvement of the contraction ratio of the actuator.

In addition, according to an aspect of the present invention, because the bag body has the plurality of the openings, the fluid can be supplied in various methods by using the plurality of the openings, and thereby smoothly performing the fluid supply to and the fluid exhaust from the bag body, while ensuring the operational characteristics of the actuator corresponding to purposes of the use.

According to an aspect of the present invention, because the covering body is knitted with the ester threads, by ensuring the constricting force against the bag body so that the bag body is not inflated to the maximum extent, the response to the inflation of the bag body can be improved, while the actuator can be reliably operated even at approximately 20 kPa of the fluid supply pressure.

In addition, according to an aspect of the present invention, because the covering body is knitted with the threads that are less than 330 decitex, the covering body is softer than that of the conventional actuator, and thereby obtaining the operational characteristic in which the covering body can follow a delicate deformation of the bag body.

According to an aspect of the present invention, because the covering body is knitted by the method called “textile braided,” while the longitudinal direction of the rhombic (bias) stitch without fluid being supplied is also considered, the covering body can flexibly follow the inflation of the bag body, while the expansion and contraction amount in the radial direction of the covering body can be increased.

According to an aspect of the present invention, because the second member is rotatably coupled to the first member onto which the actuator with a high expansion and contraction amount is arranged, while the actuator is connected to the second member with the wire member, the driving device with the increased operation range of the second member can be realized.

In addition, according to an aspect of the present invention, because the first members of the plurality of the driving devices are integrally combined, the hand device in which the finger-like members (second members) rotatably project from the human palm can be formed.

According to an aspect of the present invention, because the object can be pinched by the expanding operation of the actuator, the preferable hand device can be realized in a place where the work piece is handled in the manufacturing equipment and in FA (Factory Automation) field.

According to an aspect of the present invention, because the plurality of the actuators are parallely arranged, while the fluid supply to each of the actuators is sequentially switched, the conveyance device in which the object can be smoothly conveyed can be realized.

### BRIEF DESCRIPTION OF THE DRAWINGS

FIGS. 1(a) and 1(b) show an actuator according to an embodiment of the present invention, where FIG. 1(a) is a front view in a condition in which fluid is not supplied, and FIG. 1(b) is a front view in a condition in which fluid is supplied to operate the actuator to the maximum extent.

FIGS. 2(a) and 2(b) show inside of the actuator according to the embodiment, where FIG. 2(a) is a cross-sectional view in a condition in which fluid is not supplied, and FIG. 2(b) is a cross-sectional view in a condition in which fluid is supplied to operate the actuator to the maximum extent.

FIG. 3 is a schematic enlarged view showing that a stitch of a covering body of the actuator changes with supply of fluid.

FIGS. 4(a) and 4(b) show a bag body used for the actuator, where FIG. 4(a) is a perspective view in a deflated condition in which fluid is not supplied, and FIG. 4(b) is a perspective view in a condition in which fluid is supplied to inflate the bag body to the maximum extent.

FIGS. 5(a) and 5(b) show a variant of the bag body, where FIG. 5(a) is a perspective view in a deflated condition in which fluid is not supplied, and FIG. 5(b) is a perspective view in a condition in which fluid is supplied to inflate the bag body to the maximum extent.

FIGS. 6(a)-6(c) show another variant of the bag body, where FIG. 6(a) is a perspective view in a condition in which fluid is supplied to inflate the bag body to the maximum extent, FIG. 6(b) is a cross-sectional view along a plane perpendicular to X-axis, and FIG. 6(c) is a cross-sectional view in a plane perpendicular to the X-axis when the bag body is made inside out.

FIG. 7(a) is a perspective view showing a condition in which a sheet is folded in half, and FIG. 7(b) is a perspective view in fluid supply condition of the bag body formed from the sheet of FIG. 7(a).

FIGS. 8(a) and 8(b) show an example of deformation of the actuator to which two hoses are attached, where FIG. 8(a) is a front view in a condition in which fluid is not supplied, and FIG. 8(b) is a front view in a condition in which fluid is supplied to operate the actuator to the maximum extent.

FIG. 9 is a cross-sectional view showing inside of the actuator of the variant.

FIGS. 10(a) and 10(b) are a driving device of the present invention, where FIG. 10(a) is a plan view, and FIG. 10(c) is a bottom plan view.

FIGS. 11(a) and 11(b) are the driving device of the present invention, where FIG. 11(a) is a front view showing a condition being not in operation, and FIG. 11(b) is a front view showing a condition being in operation.

FIG. 12(a) is a front view showing a variant of the driving device, and FIG. 12(b) is a front view showing another variant of the driving device.

FIG. 13 is a plan view showing a hand device of the present invention.

FIG. 14 is a perspective view showing a conveyance device of the present invention.

FIG. 15 is a schematic cross-sectional view along the A-A line of FIG. 14.

FIG. 16 is a block diagram of a fluid supply system to be applied to the conveyance device of the present invention.

FIGS. 17(a) and 17(b) are a variant of the conveyance device, where FIG. 17(a) is a perspective view, and FIG. 17(b) is a schematic cross-sectional view along the B-B line of FIG. 17(a).

FIGS. 18(a) and 18(b) are a hand device of the present invention, where FIG. 18(a) is a schematic diagram showing a condition before pinching an object, and FIG. 18(b) is a schematic diagram showing a condition in which the object is pinched.

FIGS. 19(a) and 19(b) are a variant of the hand device, where FIG. 19(a) is a schematic diagram showing a condition before pinching an object, and FIG. 19(b) is a schematic diagram showing a condition in which the object is pinched.

Reference Numerals

| | |
|---|---|
| 1, 1′ | Actuator |
| 2, 2′ | Covering Body |
| 3 | Stitch |
| 5, 5′, 5y″, 7′, and 8 | Bag Body |
| 5e′, 5e″, 5f″, 7e′, and 7f′ | Folding Portion |
| 9 | Regulating Material |
| 10, 20, and 30 | Driving Device |
| 11 | First Member |
| 12 | Second Member |
| 16 | Wire Member |
| 40, 120, and 130 | Hand Device |
| 100, 110 | Conveyance Device |
| 102A-102N | Sensor |
| 103A-103N | Control Valve |
| 104 | Operating Fluid Generation Source |
| 105 | Control Unit |
| 121, 131 | Base Member |
| 122, 132 | Opposed Member |
| H | Hose |
| R | Space |

### BEST MODE(S) FOR CARRYING OUT THE INVENTION

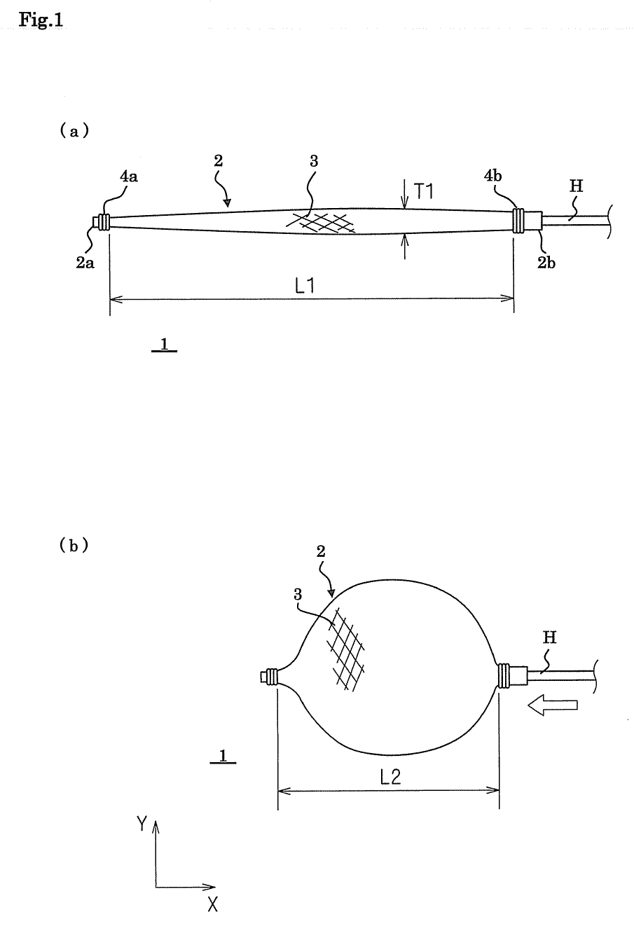

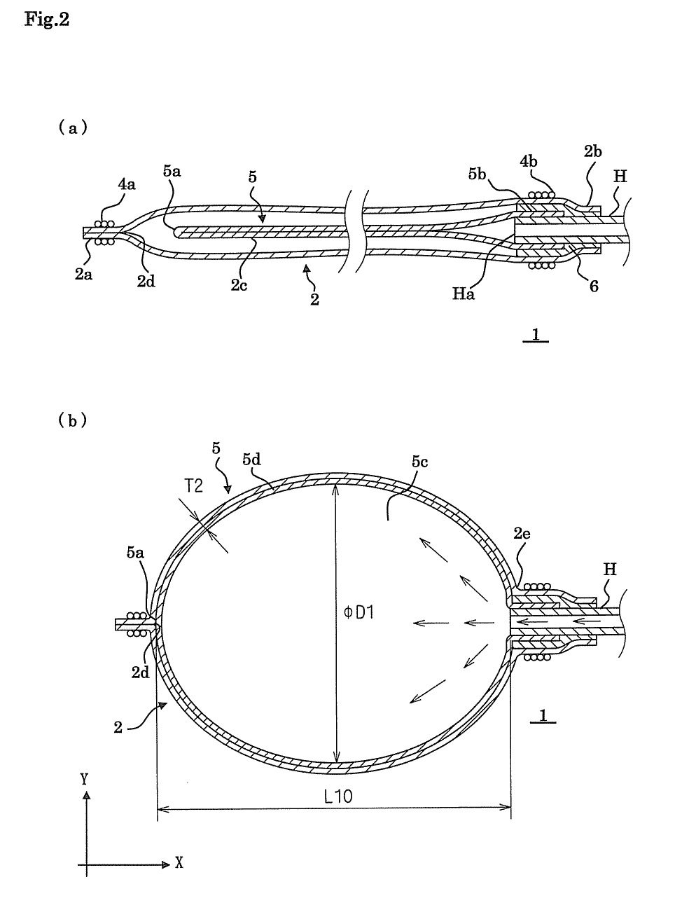

FIGS. 1(a) and 1(b), and FIGS. 2(a) and 2(b) show an actuator 1 according to an embodiment of the present invention. The actuator 1 of the present invention is mainly characterized in that a hose H through which fluid is supplied is connected to the actuator 1 so that a thickness T1 when fluid is not supplied (refer to FIG. 1(a)) is thinner than that of a conventional actuator, while a rate of contraction of a overall length of the actuator by expanding (expansion in diameter) when fluid is supplied (contraction ratio: (1−L2/L1)*100%) is improved compared to that of the conventional actuator. In this embodiment, air is used as fluid to operate the actuator 1, an operating fluid generation source (air supplying source) that is not illustrated is connected to an end of the hose H, and the fluid (air) is supplied to the actuator 1 through the hose H.

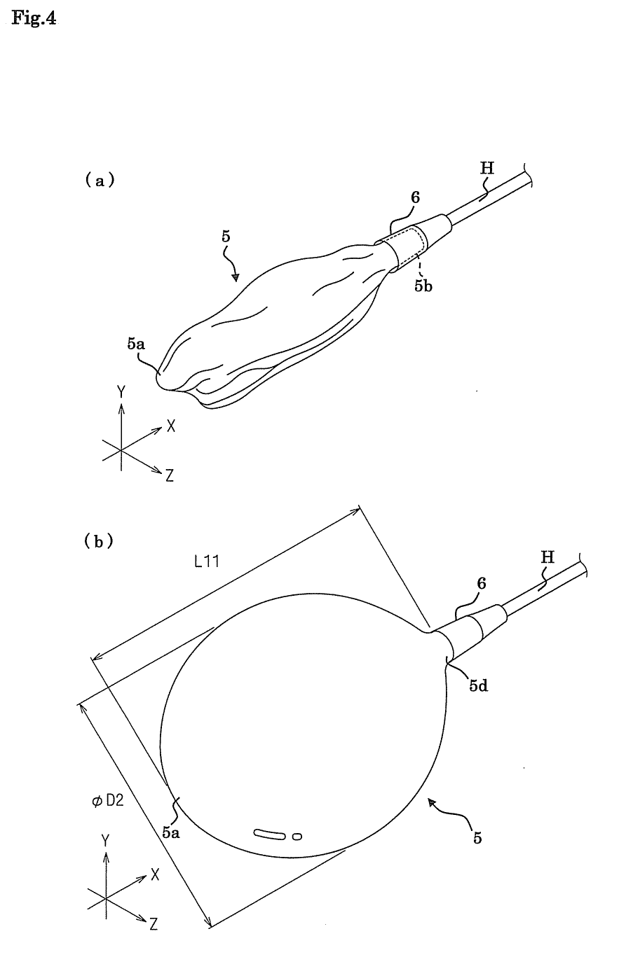

As shown in FIGS. 2(a) and 2(b), the actuator 1 includes a bag body 5 and a covering body 2 for covering the bag body 5. The bag body 5 accommodated in an internal space 2c of the covering body 2 is formed of a non-rubber material. In this embodiment, a material containing a polypropylene component that is synthetic polymer through which the fluid does not pass is used for the actuator 1. The actuator 1 is formed in a shape to be spherically inflated when supplied with the fluid as shown in FIG. 4(b) from a flat deflated condition as shown in FIG. 4(a). As the material of the bag body 5, those of a thickness T2 of a sheet portion 5d (refer to FIG. 2(b)) is 50 μm is used.

As the material of the bag body 5 of the present invention, those containing at least a component, such as polypropylene, vinyl chloride, Teflon®, polyester, polyamide, polyethylene, polyimide, polystyrene, polycarbonate and the like may be applied as the synthetic polymer having a characteristic of not passing the fluid (also possible to mix the components as described above). In an environment in which such synthetic polymer cannot be used, a less-humid environment or the like, paper through which the fluid does not pass may also be used as the material of bag body 5. In this case, because the bag body 5 is inflated, paper having a paper-balloon shape is preferable.

To the material used for the bag body 5, a thickness T2 of the sheet portion 5d is not limited to 50 μm, and a thickness within a range of 20 μm or greater but not exceeding 400 μm may also be applicable. As for the material used for bag body 5, it is preferable to selectively use materials, each having a suitable thickness of the sheet portion 5d depending on use conditions, purposes of use, and the like of the actuator 1. For example, if giving priority to thinning the actuator 1, it is preferable to use a material having a thickness T2 that is less than 100 μm, and if desired to use the actuator 1 for a long period of time, it is preferable to use a material having a thickness T2 that is over 200 μm.

The bag body 5 has an end portion 5b on a side to which the hose H is connected as an open end, and a tip-end portion 5a opposed to the open end is a closed end. The hose H is inserted into the end portion 5b, while an insertion range of the hose H is covered with a heat contraction tube 6 from outside. A predetermined amount of heat is applied to the heat contraction tube 6 to contract to fix the hose H. As shown in FIG. 4(b), when the bag body 5 is inflated to the maximum extent by supplying the fluid within a range in which the bag body 5 will not explode, a dimension of the bag body 5 is formed so that a dimension of the overall length is L11 (a size in X-direction in the drawing), and the maximum outer diameter is D2 (a diameter in a plane perpendicular to X-direction in the drawing). The direction X in the drawing is a direction parallel to a direction to which the fluid is supplied through the hose H at the end portion 5b of the bag body 5 (a direction shown by a hollow arrow in FIG. 1(b)), a direction Y is one direction perpendicular to X-direction in the plane (corresponding to the radial direction of the covering body 2 and the bag body 5), and a direction Z is a direction perpendicular to Y-direction in a plane perpendicular to X-direction.

On the other hand, the covering body 2 is expandably and contractably knitted in a cylindrical shape so as to cover the bag body 5. In this embodiment, polyester multifilament threads (275 decitex) made of ester are used for the covering body 2, and the covering body 2 is knitted by a textile braided method by a braiding device. When knitting, a stitch 3 shown in FIG. 1(a) has a rhombic (bias) shape, and the longitudinal direction of the rhombic (bias) is formed to be coincident with the longitudinal direction of the covering body 2 (X-direction) in a no-load condition so that the covering body 2 is easily expanded and contracted in a direction parallel to Y-direction as shown in FIG. 1(b), and has a required tension, while a constricting force increases when a degree of the expansion increases.

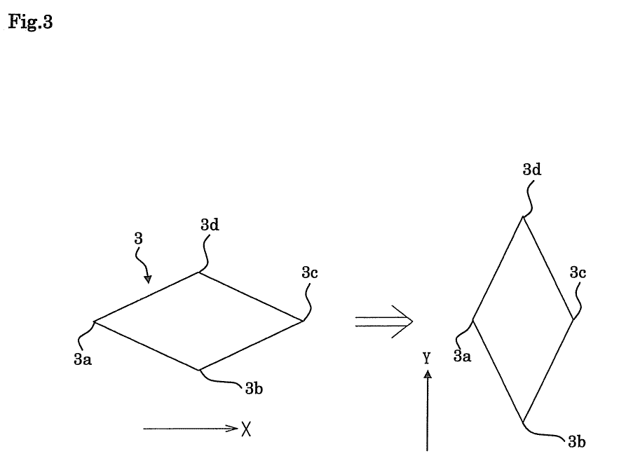

Specifically explaining a change in the shape of the stitch 3, as shown in FIG. 3, when the covering body 2 is expanded from the condition as shown in FIG. 1(a) to the condition as shown in FIG. 1(b) by supplying the fluid, the stitch 3 is deformed from a condition in which X-direction connecting a first peak 3a and a third peak 3c corresponds to the longitudinal direction, to a condition in which Y-direction connecting a second peak 3b and a fourth peak 3d corresponds to the longitudinal direction. By appropriately selecting the dimension and the material of the threads for knitting, the size of the stitch 3, and the like, the covering body 2 ensures softness, expanding and predetermined contracting properties, and constricting force as the material. In FIGS. 1(a) and 1(b), the stitches 3 in the covering body 2 are only partially illustrated, however, the stitches 3, of course, exist in an area where the illustration of the stitches 3 is omitted.

As described above, although the covering body 2 ensures the flexibility with which the covering body 2 can be expanded and contracted as the bag body 5 is deformed, a constricting force is generated to be able to constrict against a pressing force with which the bag body 5 tries to be inflated. Such a predetermined constricting force is obtained by knitting in the textile braided method by using polyester multifilament threads. When the covering body 2 expands to the maximum extent in Y-direction (refer to FIG. 2(b)), the maximum inner diameter inside of the covering body is D1 (D1<the maximum outer diameter D2 of the bag body 5), an inner longitudinal length in a direction parallel to X-direction (a distance from the tip end 2d of the inner surface to a base-end 2e of the inner surface) is L10 (L10<the overall length L11 of the bag body 5). The maximum inner volume of the covering body at this moment is smaller than the maximum volume when the bag body 5 is inflated to the maximum extent as shown in FIG. 4(b) (that is, the maximum volume of the bag body 5>the maximum inner volume of the covering body 2).

To manufacture the actuator 1 using the bag body 5 and the covering body 2 as described above, the hose H is fixed to the end portion 5b of the bag body 5 using the heat contraction tube 6, as shown in FIG. 4(a), and the bag body 5 is covered with the cylindrical covering body 2. Then, as shown in FIG. 2(a), one end portion 2b of the covering portion 2 from which the hose H extends is fixed together with the heat contraction tube 6 with which the end portion 5b of the bag body 5 is covered by winding a thread-like tying member 4b. In the covering body 2, the thread-like tying member 4a is also winded around the other tip end 2a to close the tip end 2a, and thereby the actuator 1 is completed. At this point, the tip-end portion 5a of the bag body 5 is a free end without fixing the tip-end portion 5a. To the tying members 4a and 4b, a cable tie, a tying metal, a pressure clamp, a string-like member, and the like made of a synthetic resin, other than the thread-like member may be applied.

In the completed actuator 1, because the very thin bag body 5 (the thickness per sheet 5d is 50 μm) is deflated as shown in FIG. 4(a) when the fluid is not supplied, the thickness of the actuator 1 itself is mostly coincident with the thickness of the covering body 2, and thereby thinning of the actuator can be realized. When the fluid (air) is supplied to the actuator 1 through the hose H, the bag body 5 begins to be inflated, followed by the covering body 5 being expanded so as to increase in diameter in a plane perpendicular to X-direction. At this point, because the bag body is made of the non-rubber material and the fluid does not need to be supplied against an elastic force of rubber as the conventional actuator, the bag body 5 can be smoothly inflated even if the supply pressure of the fluid is low.

When the fluid supply is further continued, the actuator 1 will be eventually deformed to the condition as shown in FIGS. 1(b) and 2(b). In this condition, the bag body 5 is inflated, the outer circumferential surface of the bag body 5 entirely contacts the inner circumferential surface of the covering body 2 (e.g., the outer circumferential surface of the tip-end portion 5a that is the free end contacts the inner tip end 2d of the covering body 2), and then the covering body 2 is outwardly pressed from inside. However, the inflation of the bag body 2 is suppressed by the constricting force of the covering body 2. Because the constricting force of the covering body 2 can constrict against the pressing force from the bag body 2 even if the supply of the fluid is continued, the covering body 2 remains in the condition in which the covering body 2 is expanded to the maximum extent.

In the condition in which the covering body 2 is expanded to the maximum extent, because the maximum volume when the bag body 5 is inflated to the maximum extent is greater than the maximum inner volume of the covering body, and the size D2 of the maximum outer diameter of the bag body 5 is larger than the size D1 of the maximum inner diameter of the covering body 2, it does not reach the condition in which the bag body 5 is inflated to the maximum extent. Therefore, if the covering body 2 is expanded to the maximum extent, a margin portion where the bag body 5 can be further inflated remains in the bag body 5 without causing a situation in which the bag body 5 is over-inflated and exploded. In addition, in this embodiment, the contraction ratio when the covering body 2 is changed from the condition in which the fluid is not supplied as shown in FIG. 1(a) to the condition in which the covering body 2 is expanded to the maximum extent (the condition as shown in FIG. 1(b)) (ratio in which an interval between the tying members 4a and 4b is contracted from the size L1 to the size L2) reaches approximately 40%, and thereby the operating amount is increased compared to that of the conventional actuator.

In the actuator 1, because the material of the bag body 5 is the non-rubber, a degree of a degradation of the material for the bag body 5 by aging is significantly decreased compared to that of a bag body in which the rubber is used as its material. Therefore, the actuator 1 of this embodiment ensures an operational characteristic stabilized over the long period of time, while the operating amount is increased with the improvement in the contraction ratio. Thus, the actuator 1 is preferable as a drive source in various robots, industrial machines, and the like.

The actuator 1, according to the present invention, is not limited to the embodiment as described above, and various variants exist. For example, the threads with which the covering body 2 may be knitted with threads that is a combination of multifilament threads and monofilament threads. It is applicable if the decitex number of each thread is less than 300 decitex. A degree of the expansion and contraction, the softness, and the constricting force may be appropriately changed by devising the threads to be used and how to knit. Gas other than air, or liquid, such as water, oil, or the like may also be applied as fluid.

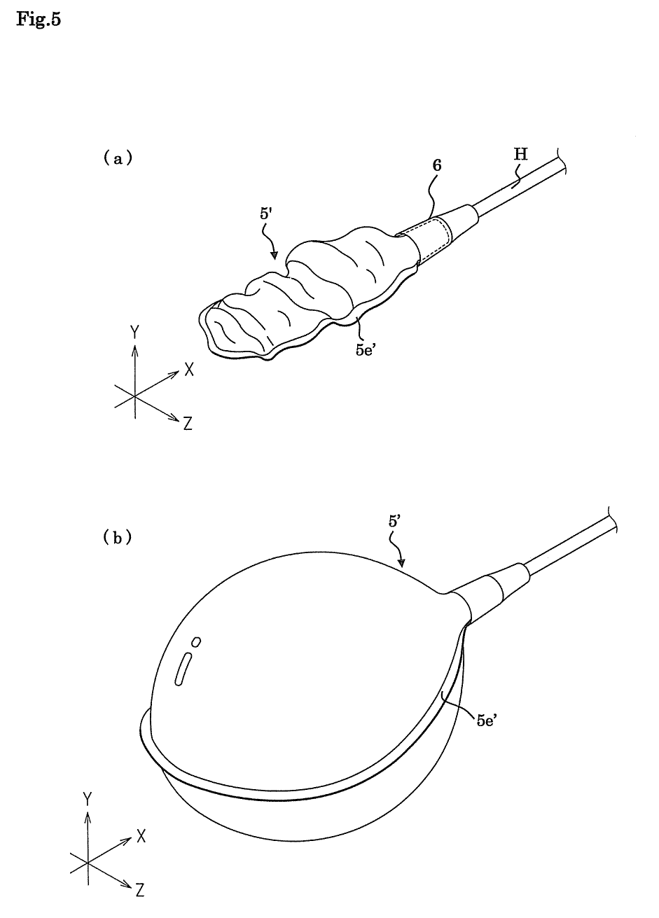

FIGS. 5(a) and 5(b) show a variant of a bag body 5′ that can be used for the actuator 1 of the present invention. The variant of the bag body 5′ is characterized in that a folding portion 5e′ is formed on peripheral thereof. The folding portion 5e′ corresponds to a portion where sheet materials forming the bag body 5′ are overlapped and pasted together by melting, and outwardly projects in a shape of a flange. That is, the folding portion 5e′ has a portion projecting in a direction parallel to X-direction in the drawing (a fluid supply direction) to regulate a folding direction of the bag body 5′.

In other words, as shown in FIG. 5(a), in the condition in which the fluid is not supplied, the bag body 5′ is deflated so that the dimension mainly in Y-direction is smaller. At this point, because rigidity of the folding portion 5e′ is high by the overlap of the seat materials, the bag body 5′ is naturally folded along the folding portion 5e′ as a folding line, so that the size of the bag body 5′ is further made compact when the fluid is not supplied. As shown in FIG. 5(b), when the fluid is supplied to the bag body 5′, the bag body 5′ is changed from a condition in which the bag body 5′ is folded along the folding portion 5e′ to a condition in which the bag body 5′ is stretched. Thus, the bag body 5′ is smoothly inflated as the actuator 1 is operated to the condition as shown in FIGS. 1(b) and 2(b).

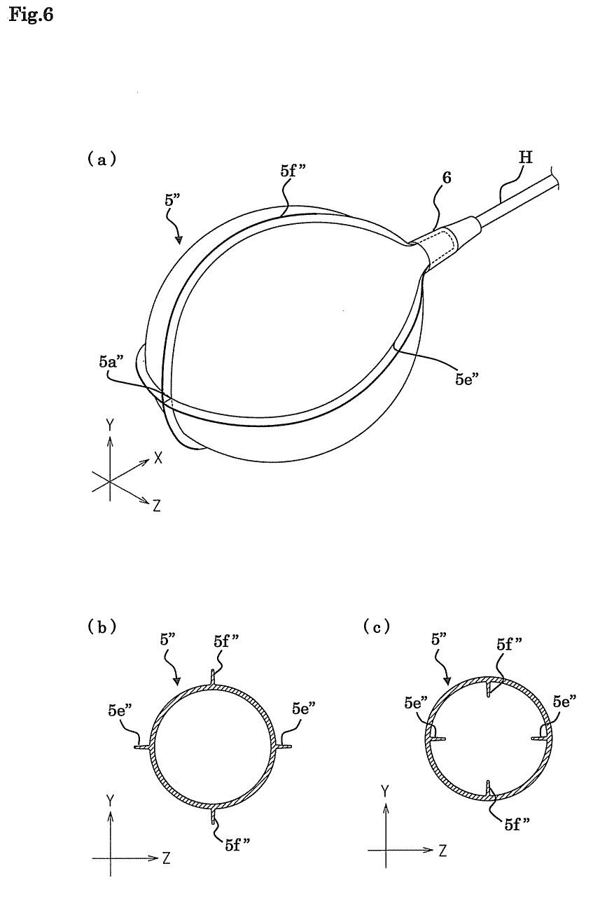

FIGS. 6(a) and 6(b) show a bag body 5″ having a plurality of folding portions 5e″ and 5f′. Each of the folding portions 5e″ and 5f′ are circumferentially formed so as to be perpendicular at a tip-end portion 5a″ of the bag body 5″. By providing the plurality of the folding portion 5e″ and 5f′, in the condition in which the fluid is not supplied, the bag body 5 is compactly folded along each of the folding portions 5e″ and 5f′ as a folding line. Therefore, the actuator 1 can be further thinned. In addition, the bag body 5″ may be made inside out so that the folding portions 5e″ and 5f′ project toward the inside of the bag body as shown in FIG. 6(c), other than outwardly projecting the folding portions 5e″ and 5f′ as shown in FIGS. 6(a) and 6(b). In the case of FIG. 6(c), because each of the folding portions 5e″ and 5f′ is not projected outside the bag body 5″, the surface of the actuator 1 (the surface of the covering body 2) can be smooth.

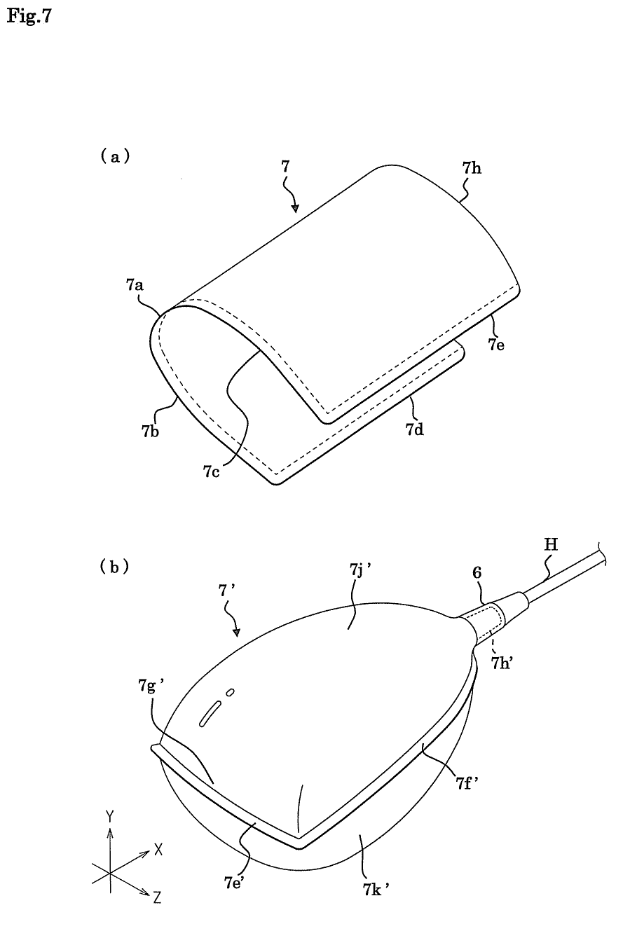

FIG. 7(a) shows a sheet 7, and FIG. 7(b) shows another variant of a bag 7′ formed from the sheet 7. As shown in FIG. 7(a), in a condition in which the rectangular sheet 7 is folded in half, opposing short side portions 7b and 7c and long side portions 7d and 7e are respectively adhered to be able to form the rectangular bag body 7′. In the bag body 7′, the adhered portions become folding portions 7e′ and 7f′ projecting in a shape of a flange, and a tip-end portion 7g′ becomes a square shape. Therefore, in the bag body 7′, because the inflation amount by the fluid supply is larger in the direction along the folding portion 7e′ having the square shape (the direction Z) than Y-direction, it is preferable for the case in which the bag body 7′ is inflated intensively only in one direction in accordance with a usage environment, an arrangement layout, and the like of the actuator. The direction to which the bag body is intensively inflated can be controlled by a setting condition of the length of the folding portion 7e′ and of redundant sheet length to top and bottom portions 7j′ and 7k′ from the folding portions 7e′ and 7f′. When the fluid is not supplied, the bag body 7′ is also compactly folded along the folding portions 7e′ and 7f′ as folding lines. In the bag body 7′, the other short side portion 7h that is not adhered in FIG. 7(a) is an open end 7h′ where the hose H is fixed with the heat contraction tube 6.

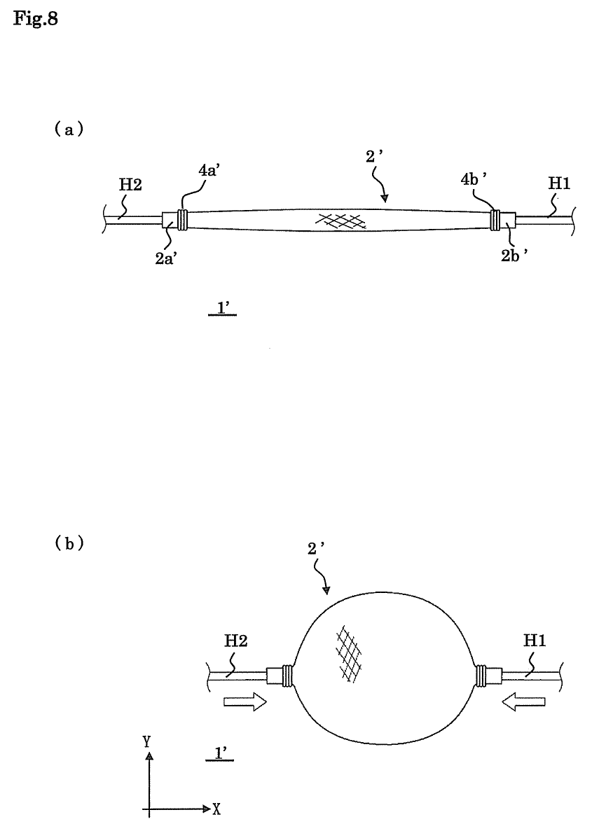

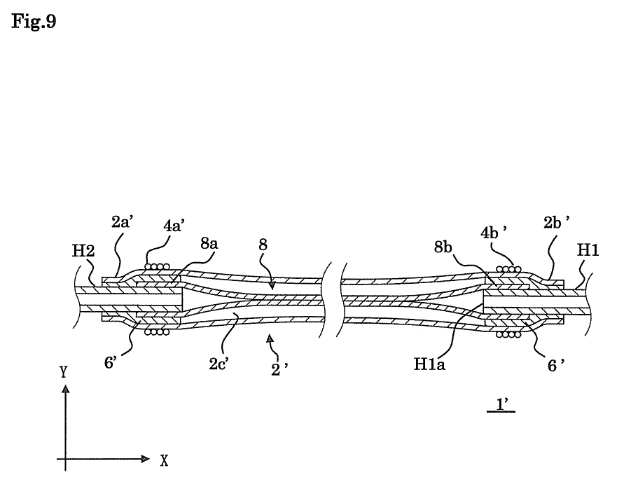

FIGS. 8(a) and 8(b), and FIG. 9 show another variant of the actuator 1′. This variant of the actuator 1′ is characterized in that a first hose H1 extends out from one end portion 2b′ of the covering body 2′, while a second hose H2 extends out from the other end portion 2a′. Corresponding to the two hoses H1 and H2, as shown in FIG. 9, a bag body 8 covered with the covering body 2′ and accommodated inside an inner space 2c′ is provide with openings 8a and 8b at both ends. A hose end H1a of the first hose H1 is inserted into one opening 8b and fixed with a heat contraction tube 6′, and the second hose H2 is similarly inserted into the other opening 8a and fixed with a heat contraction tube 6′. The both ends of the bag body 8 provided with the openings 8a and 8b are covered with both end portions 2a′ and 2b′ of the covering body 2′, and fixed together with tying members 4a′ and 4b′.

Because the bag body 8 used for such an actuator 1′ is made of a material, a dimension, and a shape equivalent to that of the bag body 5 shown in FIGS. 1 and 2, other than provision of the openings 8a and 8b at both ends, a long-term stable use and thinning of the actuator 1′ can be realized, while improving the contraction ratio. Of course, the embodiments of the bag bodies 5′, 5″, and 7′ of various variants explained in FIGS. 5-7 may be also applied to the bag body 8 of the actuator 1′. Further, the bag body 8 may be provided with two or more openings to supply and discharge of the fluid therethrough.

By attaching two hoses H1 and H2 to such an actuator 1′, the fluid may be passed through each of the openings 8a and 8b of the bag body 8 in various way, and thereby a variation is produced in the method of the fluid supply control. For example, valves for switching opening and closing of flow channels may be attached to outer hose ends of the hoses H1 and H2. Then the valve on the side of the first hose H1 is opened and the valve on the side of the second hose H2 is closed so that the fluid is supplied to the bag body 8 through the first hose H1 to inflate the bag body 8. When the bag body 8 is to be deflated, the valve on the side of the first hose H1 is closed and the valve on the side of the second hose H2 is opened so that the fluid is exhausted from the bag body 8 through the second hose H2. By controlling the fluid supply as described above, the fluid continuously flows to one direction, and thereby ensuring a smooth flow. As another method of the fluid supply, the fluid may be simultaneously supplied to the bag body 8 through both the first hose H1 and the second hose H2, while the fluid may be simultaneously exhausted from the bag body 8 through both the first hose H1 and the second hose H2 when the bag body 8 is to be deflated. In this case, because a large amount of the fluid can be quickly supplied and exhausted, an operational response of the actuator 1′ can be improved.

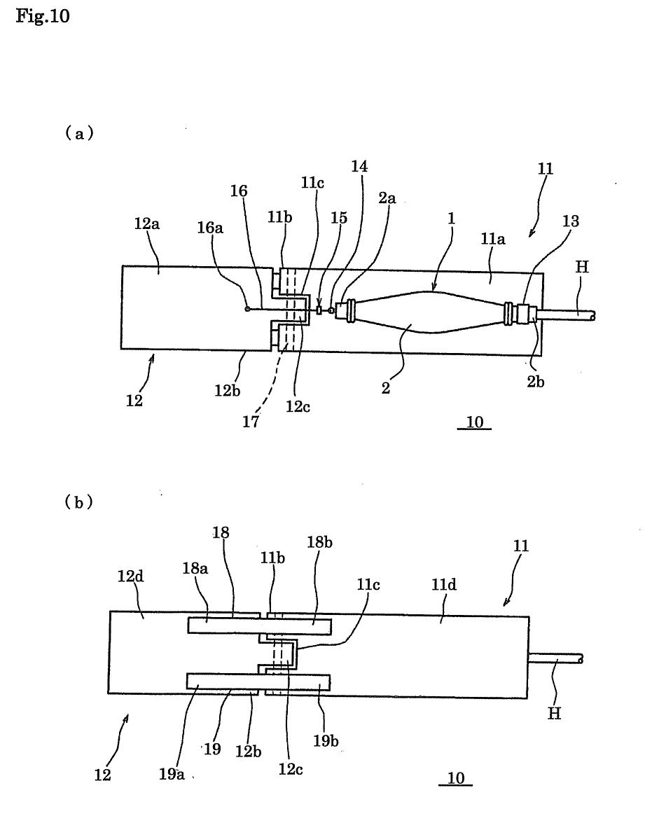

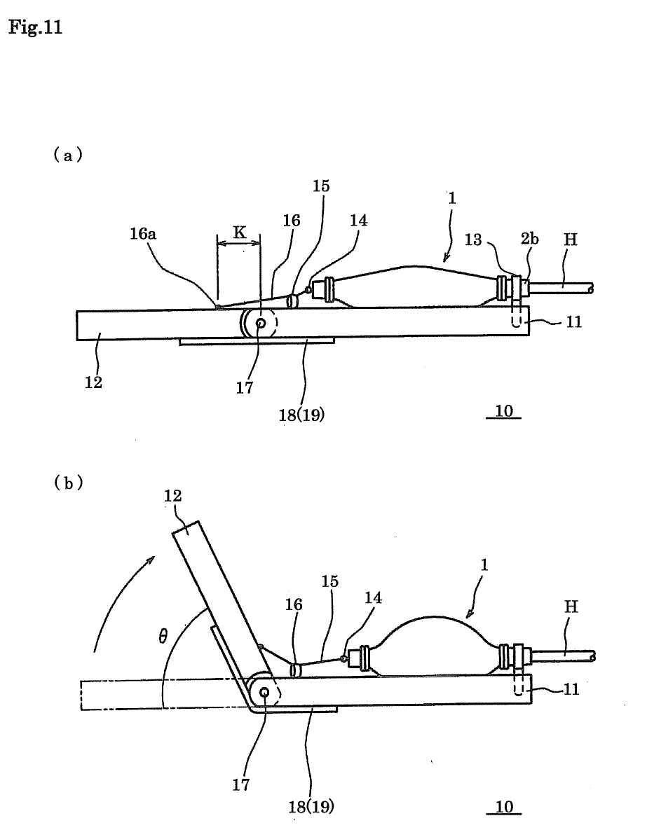

FIGS. 10(a) and 10(b), and FIGS. 11(a) and 11(b) show a driving device 10 using the actuator 1 (also including the various variants of the actuators described above). In the driving device 10, the actuator 1 is arranged and fixed on a plate-like first member 11, a second member 12 rotatably coupled to the first member 11 and the tip-end portion 2a of the covering body 2 forming the actuator 1 are coupled together through a wire member 16. The actuator 1 is operated to rotate the second member 12 (refer to FIG. 11(b)).

In the actuator 1, the end portion 2b to which the hose H is attached is inserted into a ring portion of a fixator 13 projected from the first member 11, and the end portion 2b side of the actuator is fixed to a surface 11a of the first member 11. An engaging member 14 with which the wire member 16 is engaged is attached to the tip-end portion 2a of the actuator 1. The wire member 16 engaged with the engaging member 14 is inserted through a ring-like portion of a regulating pin 15 projected from the surface 11a of the first member 11. Thus, the tip-end portion 2a side of the actuator 1 is arranged along the surface 11a of the first member 11.

In the first member 11, a concave portion 11c is formed in an end portion 11b on the side of the first member 11 coupled to the second member 12. In a condition in which a convex portion 12c provided in a coupled-side end portion 12b of the second member 12 is arranged inside the concave portion 11c, a shaft 17 is communicated with the first member 11 and the second member 12 to rotatably couple the members 11 and 12. A tip end 16a of the wire member 16 extended from the actuator 1 is fixed to a surface 12a of the second member 12. In design, a distance K from a location to which the tip end 16a is fixed to the shaft 17 (refer to FIG. 11(a)) influences a rotational angle θ of the second member 12 (refer to FIG. 11(b)).

Further, as shown in FIG. 10(b), in the driving device 10, belt-like elastic members 18 and 19 are attached on a back surface 11d of the first member 11 so as to connect the end portion 11b of the first member 11 and the coupled-side end portion 12b of the second member 12. The elastic members 18 and 19 are made of rubber pieces to cause a biasing force in the contracting direction when the elastic members 18 and 19 are stretched. One end portions 18a and 19a are adhered on a back surface 12d of the second member 12, while the other end portions 18b and 19b are adhered on the back surface 11d of the first member 11.

Therefore, as shown in FIG. 11(a), when the fluid is not supplied to the actuator 1, the first member 11 and the second member 12 are linearly lined up by the biasing force of the elastic members 18 and 19. As shown in FIG. 11(b), when the fluid is supplied to the actuator 1, the actuator is operated to be contracted, and then the wire member 16 is pulled to rotate the second member 12. Therefore, by repeating the fluid supply to and suction from the actuator 1 through the hose H, the driving device 10 rotates the second member 12 within a range between the posture shown in FIG. 11(a) and the posture shown in FIG. 11(b). Thus, a driving method like flexing human fingers can be realized by supplying or exhausting a small amount of the fluid without using a large-scale structure and a complicated construction.

The driving device 10 is not limited to the embodiment as described above, and various variants may be applied. For example, the first member 11 and the second member 12 may be in various shapes, such as a bar-like shape, a bone-like shape, and the like according to the usage, other than the plate-like elongated rectangular shape. Springs (for example, tension coil springs) may be applied to the elastic members 18 and 19. The elastic member connecting the first member 11 and the second member may be one, instead of two, and the single elastic member may be arranged so as to pass through the center in the longitudinal direction shown in FIGS. 10(a) and 10(b). As the fixator 13 fixing the end portion 2b of the actuator 1, those other than shown in the embodiments described above may be applied. The end portion 2b may be fixed to the first member 11 with adhesives instead of using the fixator 13.

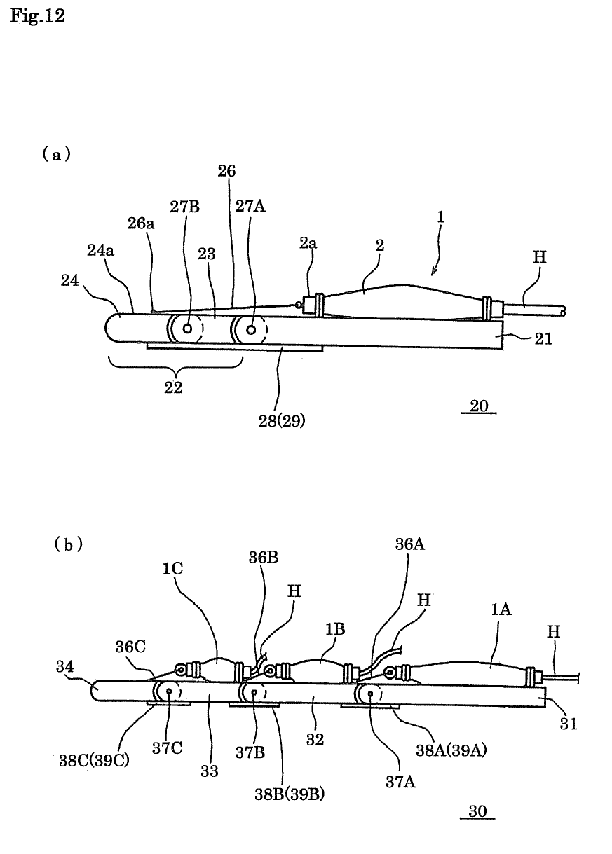

FIG. 12(a) shows a variant of a driving device 20. The driving device 20 is characterized in that a second member 22 rotatably coupled to a first member 21 on which the actuator 1 is arranged is bendable (rotatable). That is, the second member 22 includes a plate-like base-end portion 23 to be coupled to the first member 11, and a plate-like tip-end portion 24 bendably (rotatably) attached to the base-end portion 23.

A coupling method between the first member 21 and the base-end portion 23 of the second member 22, and a coupling method between the base-end portion 23 and the tip-end portion 24 are basically similar to the configuration as shown in FIGS. 10(a) and 10(b). That is, the base-end portion 23 of the second member 22 is coupled to the first member 21 so as to rotate around a first shaft 27A. The tip-end portion 24 is coupled to the base-end portion 23 so as to rotate around a second shaft 27B. In a back surface that is opposite to a surface where the actuator 1 is fixedly arranged with adhesives, elastic members 28 and 29 are attached continuously from the first member 21 to the tip-end portion 24 of the second member 22 to connect the first member 21 and the tip-end portion 24. Further, a tip end 26a of a wire member 26 extended out from the tip-end portion 2a of the actuator 1 is attached to a surface 24a of the tip-end portion 24 of the second member 22.

In such a driving device 20, when the fluid is supplied to the actuator 1, because the actuator is operated to be contracted and then pulls the wire member 26, the base-end portion 23 is rotated around the first shaft 27A, while the tip-end portion 24 is rotated around the second shaft 27B. Thus, an operation like bending and rotating the second member 22 can be obtained. In the result, a rotation range of the second member 22 (the tip-end portion 24) with a simple construction may be larger than that of the driving device 10 shown in FIG. 11(b).

FIG. 12(b) shows a driving device 30 as another variant. The driving device 30 of this variant is characterized in that the driving devices 10 shown in FIGS. 10(a) and 10(b) are linearly and rotatably coupled with each other. Specifically, a first member 31, a second member 32, a third member 33, and a fourth member 34 are rotatably coupled in series as similar to the construction shown in FIGS. 10(a) and 10(b). A first actuator 1A, a second actuator 1B, and a third actuator 1C are fixedly arranged on the first member 31, the second member 32, and the third member 33, respectively. Wire members 36A-36C extended respectively out from the actuators 1A-1C are attached to the respective members 32-34 to be operated. Elastic members 38A(39A) to 38C(39C) are attached to coupling locations of the members 31-34, respectively. The elastic members may be integrated so as to continuously connect the first member 31 through the fourth member 34.

In the driving device 30, the fluid may be supplied to all of the actuators 1A-1C or supplied individually through the hose H. Thus, by appropriately controlling the supply method on a side of a device supplying the fluid to the driving device 30 (the operating fluid generation source), the members 32-34 of the driving device 30 are complexly operated. For example, if the fluid is supplied to all of the actuators 1A-1C, the members 32-34 are rotatably operated so that the first member 31 through the fourth member 34 form a J-shape as a whole. Alternatively, when the fluid is supplied only to the third actuator 1C, an operation just like moving only a fingertip can be realized. Similarly, only the second actuator 1B or only the first actuator 1A may be operated. Of course, two actuators, such as the first actuator 1A and the second actuator 1B, the first actuator 1A and the third actuator 1C, or the second actuator 1B and the third actuator 1C may be simultaneously operated.

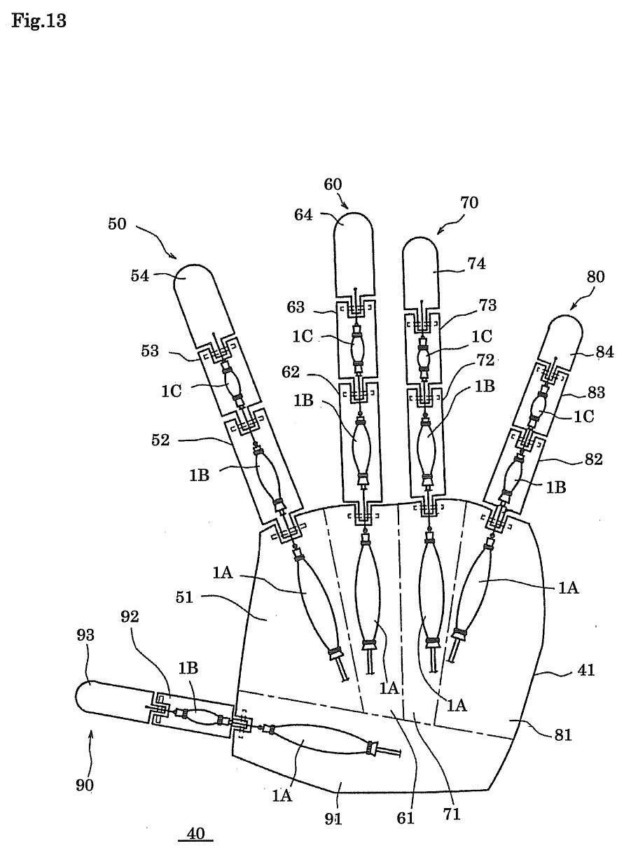

FIG. 13 shows a hand device 40 using first to fifth driving devices 50-90 having the construction equivalent to the driving devices 10-30 described above. In the hand device 40, the first to fourth driving devices 50-80, having the construction equivalent to the driving device 30 shown in FIG. 12(b) are arranged at positions corresponding to that of index to little fingers of a human hand. The fifth driving device having a construction in which a single actuator and a single rotatable member are omitted from the driving device 30 shown in FIG. 12(b) is arranged at a position corresponding to that of a thumb of a human hand.

Further, in the hand device 40, first members 51-91 of the first to fifth driving devices 50-90 (corresponding to a plurality of areas surrounded by one-dot-dashed lines in the drawing) are integrally combined to form a palm portion 41 corresponding to a human palm. In order to form the palm portion 41 into a shape according to that of a human hand, the shapes of the first members 51-91 are changed in shapes unlike the first member 11 shown in FIG. 10(a) that is a rectangular shape.

In the hand device 40 having such a construction, by appropriately operating the actuators 1A-1C of the driving devices 50-90 (in the fifth driving device 90, the actuators 1A and 1B), the members 52-54, 62-64, 72-74, 82-84, and 92-93 of the respective driving devices 50-90 are rotated to perform a human-finger-like motion. Therefore, the hand device 40 may grip various shaped objects, and it may be used as an artificial hand. The surface of the hand device 40 may be smoothened and the hand device 40 may be covered with a rubber glove for protecting the actuators 1A, 1B, etc. In addition, a die forming may be performed so as to cover the peripheral of the hand device 40 with an expandable and contractable synthetic resin having flexibility.

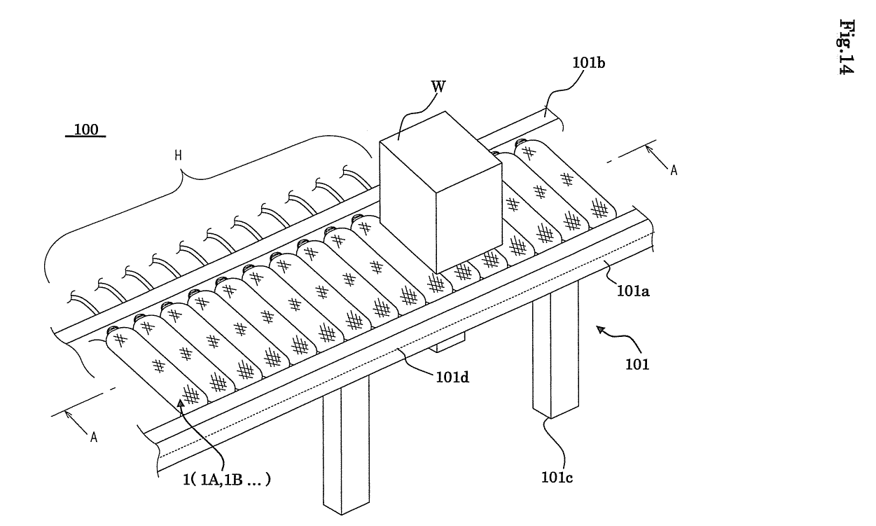

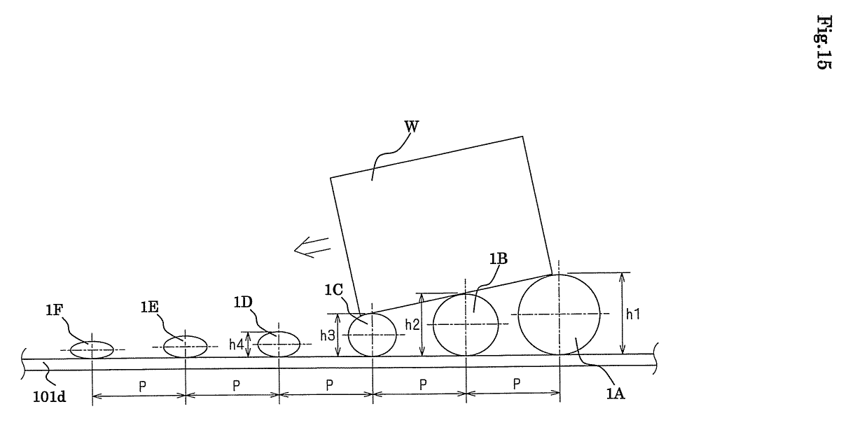

FIGS. 14 and 15 show a conveyance device 100 constructed using the actuators 1A, 1B, 1C, etc. shown in FIGS. 1 and 2. The conveyance device 100 conveys an object W to be conveyed. In the conveyance device 100, a bottom plate portion 101d is provided between frame portions 101a and 101b on both sides extending to a conveying direction, while the frame portions 101a and 101b are supported by a plurality of leg portions 101c. A plurality of the actuators 1A, 1B, 1C, etc. are arranged in parallel on the bottom plate portion 101d so that the longitudinal directions of the actuators are perpendicular to the conveying direction. An interval P at which the actuators 1A, 1B, etc. are arranged is set so that the object W can be placed on the actuators 1A, 1B, etc. In this embodiment, the interval P is equal to the diameter of the actuator when inflated to the maximum extent. The actuators of various variants as described above may be applied to each of the actuators 1A, 1B, etc. used for the conveyance device 100.

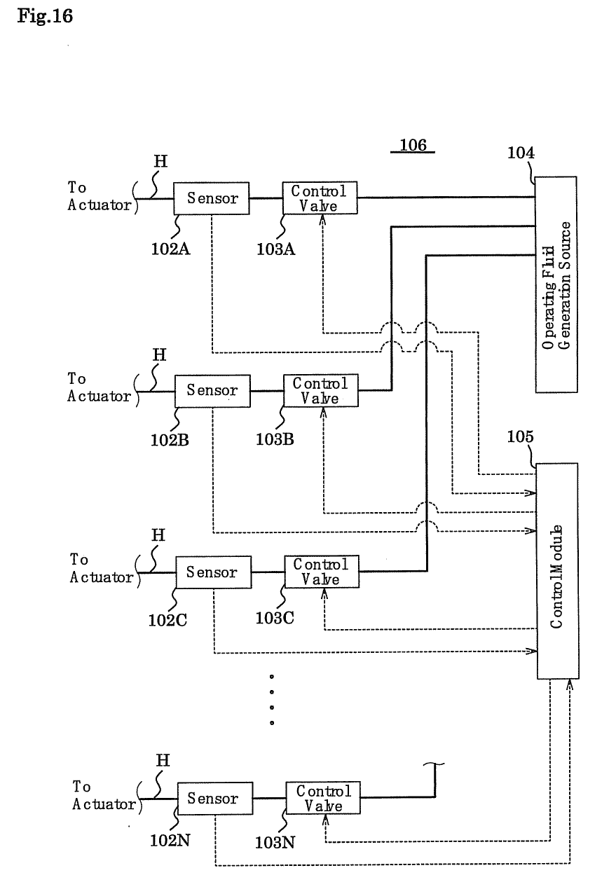

FIG. 16 is a block diagram showing a fluid supply system 106 in which the fluid is supplied to each of the actuators 1A, 1B, etc. through the hose H. In the fluid supply system 106, the same number of control valves 103A, 103B, etc. and sensors 102A, 102B, etc. for detecting pressures as the number of the actuators 1A, 1B, etc. are sequentially connected to the operating fluid generation source 104 for generating the fluid to be supplied. The control valves and the sensors are respectively connected to the actuators 1A, 1B, etc. through the hose H. The fluid supply system 106 includes a control module 105 to control the fluid supply.

A pump, a compressor, a reciprocating piston mechanism, or the like that generates compressed fluid may be applied to the operating fluid generation source 104. Because the actuators 1A, 1B, etc. used for the conveyance device 100 are operable at a low pressure, small and low-power actuators, instead of those generating the compressed fluid at a high pressure, may be applied to the operating fluid generation source 104.

Valves for switching fluid channels to the actuators 1A, 1B, etc. are built in the control valves 103A, 103B, etc., respectively. As the fluid channel types, there are a fluid channel through which the fluid generated in the operating fluid generation source 104 is supplied to each of the actuators 1A, 1B, etc., a channel blocking between the operating fluid generation source 104 and each of the actuators 1A, 1B, etc., and a channel opening the hose connected to the actuators 1A, 1B, etc. to the atmosphere. The built-in valves may be electrically operated based on a control of the control module 105. The sensors 102A, 102B, etc. detect the supply pressure of the fluid that is supplied to the actuators 1A, 1B, etc., and transmit results of the detection to the control module 105.

The control module 105 (corresponding to a switching means) operates the valves of the control valves 103A, 103B, etc. so as to sequentially switch the actuators 1A, 1B, etc. to which the fluid is supplied, respectively, to control the switching of the channels. As a specific content of the control, the control module 105 controls the first control valve 103A to supply the fluid to the first actuator 1A positioned at the right end in FIG. 15, then controls the second control valve 103B to supply the fluid to the second actuator 1B after a predetermined period of time, and then controls the third control valve 103C to supply the fluid to the third actuator 1C after the predetermined period of time. By controlling as described above, in a condition in which the first actuator 1A is inflated to the maximum extent as shown in FIG. 15 (a height from the bottom plate portion 101d is “h1”), the second actuator 1B is in a condition in which it is inflated to a middle extent (a height “h2”), and the third and fourth actuators 1C and 1D are in conditions in which they are slightly inflated (heights “h3” and “h4,” respectively; h4<h3<h2<h1).

Further, the control module 105 determines whether the actuators 1A, 1B, etc. are in conditions in which they are inflated to the maximum extent based on the detection results transmitted from the sensors 102A, 102B, etc., respectively. When the supply pressures reported by the detection results reach reference values corresponding to the condition in which the actuators are inflated to the maximum extent, the control valves 103A, 103B, etc. are controlled so as to be switched to the fluid channels opened to the atmosphere. Such a control is continuously performed by the control module 105 to sequentially inflate each of the actuators 1A, 1B, etc., and when the actuators are inflated to the maximum extent, they are sequentially deflated, and such a operational condition will be repeated.

In the conveyance device 100, the actuators 1A, 1B, etc. are operated like a vermicular manner as a whole as described above. Therefore, when the object W to be conveyed is placed on the actuators 1A, 1B, etc., the object W is conveyed to a direction to which the heights of the actuators are lower (the conveying direction) by gravity as the height of each of the operated actuators 1A, 1B, etc. sequentially changes to h1-h4. In addition, because the actuators 1A, 1B, etc. have soft surfaces, the object W is not scratched during being conveyed when the object W contacts the surfaces, while noises associated with the conveyance is hardly generated. Other than the case in which the object W is directly conveyed, the object W may be placed on a conveying platform, such as a tray, and the tray may be conveyed by the actuators 1A, 1B, etc.

Alternatively, in the fluid supply system 106 shown in FIG. 16, in order to reliably prevent an explosion of the bag body 5 used for each actuator by preventing the excessive fluid supply to the bag body 5, flow sensors may be provided between the control valves 103A, 103B, etc. and the actuators 1A, 1B, etc., respectively. The flow sensors detect the flows of the fluid supplied to the actuators, and the detected results are continually transmitted to the control module 105. The control module 105 determines whether a flow rate transmitted from the flow sensors (detection values) reaches an amount that is a value after subtracting a safety value from the maximum allowable flow rate of the bag body 5 (corresponding to the maximum volume of the bag body 5) (“threshold;” the threshold may be stored in an internal memory of the control module 105 in advance). When the detection value reaches the threshold, the switching of the control valves 103A, 103B, etc. is controlled so as to stop the fluid supply to the actuators. The fluid supply system 106 may be constructed with at least a supply line to the actuators. If the actuators 1 are independently used as shown in FIGS. 1 and 2, the fluid supply system 106 having a supply line may be applied.

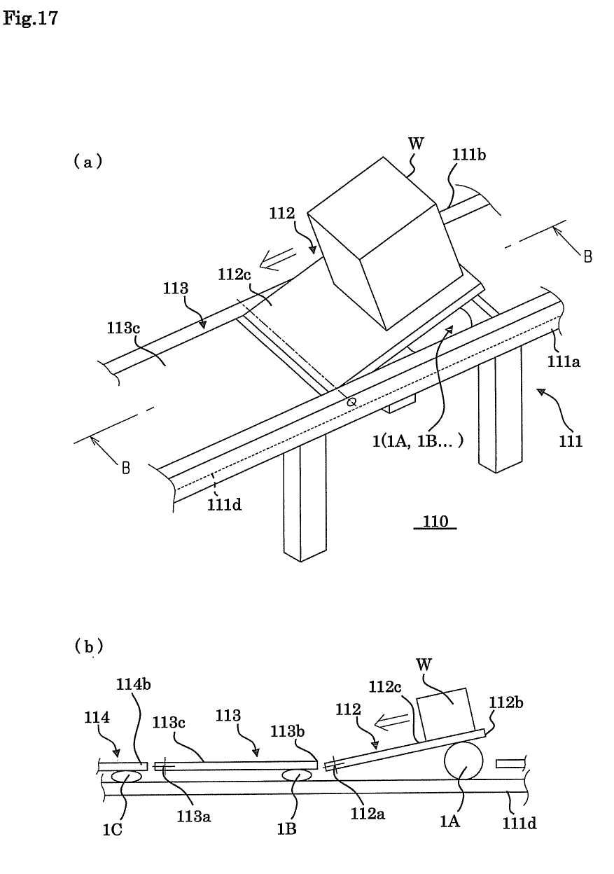

FIGS. 17(a) and 17(b) show a variant of a conveyance device 110. The conveyance device 110 of this variant is characterized in that the object W is not directly placed on the actuators 1A, 1B, etc., but placing it on slopable plate members 112, 113, 114, etc., while the object W is moved as a result of sloping each of the plate members 112, 113, 114, etc. by lifting by each of the inflated actuators 1A, 1B, etc. respectively. The conveyance device 110 is provided with a bottom plate portion 111d between frame portions 111a and 111b on both sides, while a plurality of the plate members 112, 113, etc. that rotate about center axes 112a, 113a, etc. are attached to the frame portions 111a and 111b on both sides with a space from the bottom plate portion 111d. In the conveyance device 110, the actuators 1A, 1B, 1C, etc. are respectively arranged between the plate members 112, 113, 114, etc. and the bottom plate portion 111d, and on the side of free ends 112b, 113b, 114b, etc. of the plate members 112, 113, 114, etc. It is preferable that placing surfaces 112c, 113c, etc. of the plate members 112, 113, etc. are finished to reduce their frictional resistances so that the object W easily slides thereon.

Although a fluid supply system to be applied to such a variant of the conveyance device 110 is basically equivalent to the construction shown in FIG. 16 (the fluid supply system will be explained by using the reference numerals of FIG. 16), the time interval at which the fluid is supplied to the actuators 1A, 1B, etc. are set corresponding to the slope of the plate members 112, 113, etc. That is, in order to reliably convey the object W, the control valves 103A, 103B, etc. are switched to limit to operate the plate members 112, 113, etc. to be operated to one at a time. For example, the first plate member 112 is sloped, and it is then returned to the horizontal posture, and after that, the second plate member 113 is then sloped.

Therefore, when the fluid is supplied to the first actuator 1A, the control module 105 operates the first actuator 1A until the first actuator 1A is inflated to the maximum extent, and after that, the first control valve 103A is switched to the fluid channel opening to the atmosphere. Then, after the control module 105 determines from the detection results of the sensor 102A that the first actuator 1A is deflated, the control module 105 controls the switching of the valve of the first control valve 103B so as to supply the fluid to the next second actuator 1B. When the second actuator 1B is inflated to the maximum extent, the second control valve 103B is switched to be opened to the atmosphere. Such a control will be sequentially performed to the third actuator 1C, the fourth actuator, and the like.

As a result, in the conveyance device 110, the plate members 112, 113, etc. are sequentially sloped and returned to the horizontal position one by one, and thereby the object W is conveyed. Because this variant of the conveyance device 110 conveys the object W using the plate members 112, 113, etc., the number of the actuators may be reduced compared to that of the conveyance device 100 shown in FIG. 14. Thus, the control burden according to the fluid supply system 106 may be reduced. Further, the object W may be smoothly conveyed because it easily slides on the placing surfaces 112c, 113c, etc. of the plate members 112, 113, etc.

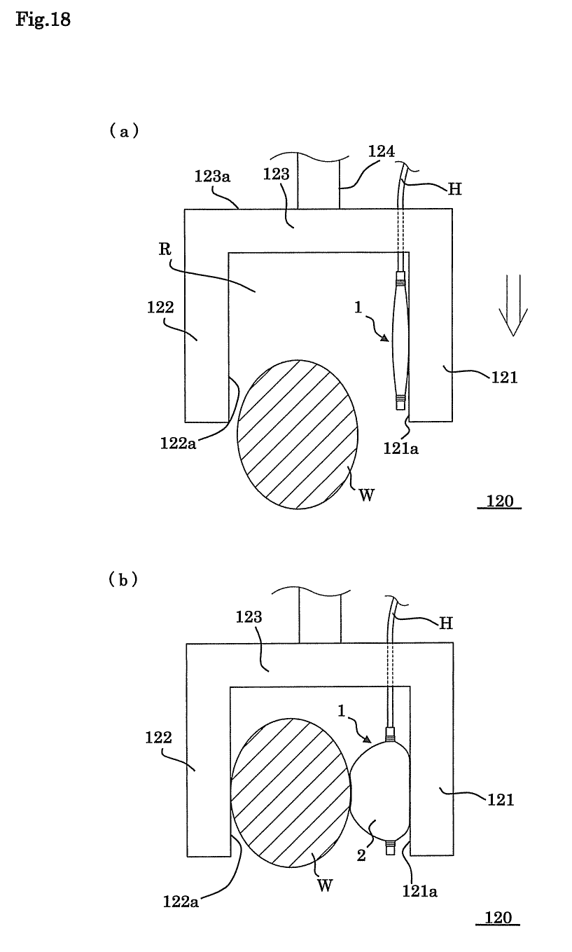

FIGS. 18(a) and 18(b) show a hand device 120 constructed by using the actuator 1 shown in FIGS. 1 and 2 (also including the actuators of various variants). The hand device 120 is preferable for handling (pinching, grasping) of an object (work piece) W in a manufacturing equipment and the like in FA field, and thus, the actuator 1 is fixedly arranged on an inner surface 121a of a base member 121 that ensures a required rigidity upon the handling of the object W. In the hand device 120, an opposing member 122 is provided so as to oppose to the actuator 1 with a space R, which is larger than an outer shape of the object W, and the opposing member 122 and the base member 121 are coupled with a coupling member 123. Fixing of the actuator 1 to the base member 121 may be performed by a method equivalent to that of the driving device 10 shown in FIGS. 10(a) and 10(b). An attachment portion 124 may be projected from an outer surface 123a of the coupling member 123 of the hand device 120, and the hand device 120 may be coupled to a movement mechanism provided in a manufacturing equipment, a robot arm end of an industrial robot, or the like via the attachment portion 124.

In order to pinch the object with the hand device 120 described above, first, the hand device is coupled to the movement mechanism provided in the manufacturing equipment, the robot arm end of the industrial robot, or the like so as to move the hand device 120. Next, the hand device 120 is moved above the object W by driving the manufacturing equipment or the industrial robot, and then, the hand device is lowered so that the object W is positioned within the space R of the hand device 120. In such a condition, when the hand device activates the actuator 1, the object W is pinched between the surface of the covering body 2 of the actuator 1 with an increased diameter, and the inner surface 122a of the opposing member 122. After that, the fluid is supplied through the hose H to maintain a condition in which the actuator is operated, and the hand device 120 is moved by driving of the manufacturing equipment or the industrial robot while pinching the object W, and thereby the object W is moved to a destination. When moved to the destination, the operation of the actuator is stopped to deflate the actuator 1, the hand device 120 releases the object W. Thus, because the hand device 120 of the present invention can pinch and release the object W with a simple mechanism, it can be utilized at processes in which various objects in a factory are moved.

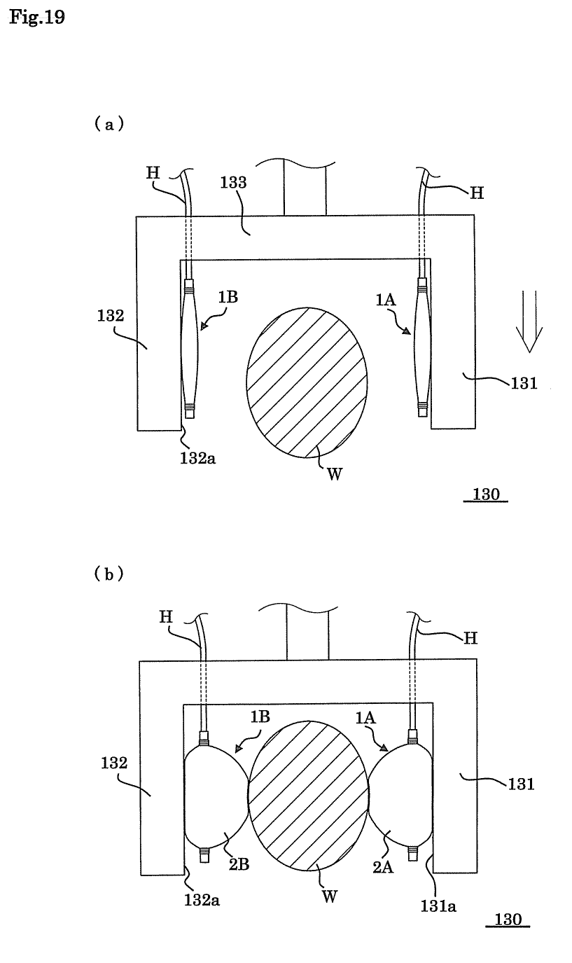

FIGS. 19(a) and 19(b) show a variant of a hand device 130. The hand device 130 of this variant is characterized in that the first actuator 1A is fixedly arranged on a base member 131, while the second actuator 1B is also fixedly arranged on an inner surface 132a of an opposing member 132 to which the first member 11 is coupled through a coupling member 133. When the object W is to be pinched, the object W positioned in the space R may be firmly pinched from both sides by operating both the actuators 1A and 1B (refer to FIG. 19(b)).

The hand device 130 of this variant may have various usage depending on the way to operate each of the actuators 1A and 1B. For example, by unequally changing the operating amount of both the actuators 1A and 1B, the object W can be moved within a range in which the diameter of each of the actuators 1A and 1B can be increased, without moving the hand device 130 by the manufacturing equipment or the industrial robot. If the object W is larger in size, only one of the actuators may be operated to pinch the object W, and thereby the size range of the object W to be pinched can be larger. When both the actuators 1A and 1B are operated to pinch the object W, because the object W is pinched from both sides, the hand device 130 can firmly pinch the object W compared to the hand device 120 shown in FIGS. 18(a) and 18(b).

### INDUSTRIAL APPLICABILITY

A non-rubber material is used for a bag body inside a covering body of an actuator, while a dimension and shape of the bag body are suitably set with respect to the covering body. Thus, a long-term stable use and thinning of the actuator may be realized. Such an actuator may be applied to a driving source of a driving device, a hand device, a conveyance device, and the like.

1.-13. (canceled)

14. An actuator including a bag body that is inflated when supplied with fluid, and a covering body that covers the bag body and expands and contracts as the bag body is deformed, the actuator characterized in that:
the bag body is formed of a non-rubber material, while the maximum volume of the bag body when inflated to the maximum extent is greater than the maximum internal volume of the covering body when expanded to the maximum extent; and
the covering body has a constricting force to suppress the inflation of the bag body when the covering body is expanded to the maximum extent.

15. An actuator including a bag body that is inflated when supplied with fluid, and a covering body that covers the bag body and expands and contracts as the bag body is deformed, the actuator characterized in that:
the bag body is formed of a non-rubber material, while the maximum outer diameter of the bag body when inflated to the maximum extent is larger than the maximum inner diameter of the covering body when expanded to the maximum extent, and the overall length of the bag body when inflated to the maximum extent is larger than the inner longitudinal length of the covering body when the covering body is expanded to the maximum extent; and
the covering body has a constricting force to suppress the inflation of the bag body when expanded to the maximum extent.

16. The actuator according to claim 14, wherein the material of the bag body is synthetic polymer or paper.

17. The actuator according to claim 15, wherein the material of the bag body is synthetic polymer or paper.

18. The actuator according to claim 14, wherein the material of the bag body has a thickness of a sheet portion of 20 μm or greater but not exceeding 400 μm.

19. The actuator according to claim 15, wherein the material of the bag body has a thickness of a sheet portion of 20 μm or greater but not exceeding 400 μm.

20. The actuator according to claim 16, wherein the material of the bag body has a thickness of a sheet portion of 20 μm or greater but not exceeding 400 μm.

21. The actuator according to claim 17, wherein the material of the bag body has a thickness of a sheet portion of 20 μm or greater but not exceeding 400 μm.

22. The actuator according to claim 14, wherein the bag body is formed with a folding portion to be a folding line without fluid being supplied.

23. The actuator according to claim 15, wherein the bag body is formed with a folding portion to be a folding line without fluid being supplied.

24. The actuator according to claim 16, wherein the bag body is formed with a folding portion to be a folding line without fluid being supplied.

25. The actuator according to claim 17, wherein the bag body is formed with a folding portion to be a folding line without fluid being supplied.

26. The actuator according to claim 18, wherein the bag body is formed with a folding portion to be a folding line without fluid being supplied.

27. The actuator according to claim 19, wherein the bag body is formed with a folding portion to be a folding line without fluid being supplied.

28. The actuator according to claim 20, wherein the bag body is formed with a folding portion to be a folding line without fluid being supplied.

29. The actuator according to claim 21, wherein the bag body is formed with a folding portion to be a folding line without fluid being supplied.

30. The actuator according to claim 14, wherein the bag body has a plurality of openings through which fluid passes.

31. The actuator according to claim 15, wherein the bag body has a plurality of openings through which fluid passes.

32. The actuator according to claim 16, wherein the bag body has a plurality of openings through which fluid passes.

33. The actuator according to claim 17, wherein the bag body has a plurality of openings through which fluid passes.
